(19) United States
(12) Patent Application Publication
(10) Pub. No.: US 2020/0286091 A1
(43) Pub. Date: Sep. 10, 2020

(54) AUTOMATED MULTI-CURRENCY REFUND SERVICE

(71) Applicant: Alibaba Group Holding Limited, George Town (KY)

(72) Inventor: Dengchun Ji, Hangzhou (CN)

(73) Assignee: Alibaba Group Holding Limited, George Town (KY)

(21) Appl. No.: 16/884,923

(22) Filed: May 27, 2020

Related U.S. Application Data
(63) Continuation of application No. PCT/CN2019/078078, filed on Mar. 14, 2019.

(30) Foreign Application Priority Data
Jun. 12, 2018 (CN) 201810603373.6

(51) Int. Cl. G06Q 20/40; G06Q 10/10; G06Q 40/00; G06Q 20/38; G06Q 40/04

(52) U.S. Cl. CPC G06Q 20/407; G06Q 10/10; G06Q 40/04; G06Q 20/381; G06Q 40/12

(57) ABSTRACT

A multi-currency refund service processing method is disclosed. The method includes: receiving a refund request for a target transaction; in response to receiving the refund request, determining a pre-stored historical record of the target transaction; calculating a received refund amount of a current refund based on a total received refund amount in the historical record and a payable refund amount specified in the refund request; determining a rounding policy of the current refund and calculating a rounding difference based on a calculated paid refund amount; updating the total received refund amount in the historical record by using the calculated rounding difference; and generating a multi-currency refund service of the target transaction to be processed based on an updated total received refund amount.

### CROSS-REFERENCE TO RELATED APPLICATIONS

This application is a continuation of PCT Application No. PCT/CN2019/078078, filed on Mar. 14, 2019, which claims priority to Chinese Patent Application No. 201810603373.6, filed on Jun. 12, 2018, and each application is hereby incorporated by reference in its entirety.

### TECHNICAL FIELD

Implementations of the present specification relate to the field of Internet application technologies, and in particular, to multi-currency refund service processing.

### BACKGROUND

In a multi-currency transaction scenario, a payer and a payee can use different currencies for a transaction by using a payment institution. For example, after the payer pays an amount in euros, the payment institution performs currency conversion to enable the payee to receive an amount in dollars. Similarly, if the payee initiates a refund to the payer, the payment institution also performs currency conversion. Regardless of payment or refund, a value obtained by the payment institution based on an exchange rate during currency conversion usually includes multiple decimals and needs to be rounded. Therefore, when a multi-currency refund service is processed, there is a refund amount deviation. If only one refund or a few refunds are performed in a certain transaction, a deviation may be relatively small. However, when there are a relatively large quantity of refunds in the same transaction, deviation accumulation and expansion may be caused.

Based on the solution in the existing technology, a more proper multi-currency refund service processing solution is needed.

### SUMMARY

To alleviate the previous technical problem, implementations of the present specification provide multi-currency refund service processing methods and apparatuses.

### Technical Solutions are as Follows:

A multi-currency refund service processing method is provided, where the method includes: receiving a refund request for a target transaction, and reading a pre-stored historical record of the target transaction; calculating a received refund amount of the current refund based on a total received refund amount in the historical record and a payable refund amount specified in the current refund request; determining a rounding policy of the current refund and calculating a rounding difference based on a calculated paid refund amount; and updating the total received refund amount in the historical record by using the calculated rounding difference, so that a multi-currency refund service of the target transaction is subsequently processed based on an updated total received refund amount.

A multi-currency refund service processing apparatus is provided, where the apparatus includes: a historical record read module, configured to receive a refund request for a target transaction, and read a pre-stored historical record of the target transaction; a refund amount calculation module, configured to calculate a received refund amount of the current refund based on a total received refund amount in the historical record and a payable refund amount specified in the current refund request; a rounding policy determining module, configured to determine a rounding policy of the current refund and calculate a rounding difference based on a calculated paid refund amount; and a historical record update module, configured to update the total received refund amount in the historical record by using the calculated rounding difference, so that a multi-currency refund service of the target transaction is subsequently processed based on an updated total received refund amount.

According to the technical solutions provided in the implementations of the present specification, when a payment institution processes a multi-currency refund service, for a certain refund request of a multi-currency transaction, instead of separately performing exchange rate-based conversion and then determining whether to perform rounding only for the current received refund amount, the payment institution centrally calculates a paid refund amount and determines a rounding policy with reference to historical refunds of the same transaction. Therefore, when the multi-currency refund service is processed, the refund amount and the rounding policy can be determined more properly, to alleviate accumulation and expansion of refund amount deviations caused by multiple refunds.

It is worthwhile to understand that the previous general description and the following detailed description are merely examples and explanations, and cannot limit the implementations of the present specification.

In addition, any of the implementations of the present specification does not need to achieve all the previous effects.

### BRIEF DESCRIPTION OF DRAWINGS

To describe the technical solutions in the implementations of the present specification or in the existing technology more clearly, the following briefly describes the accompanying drawings needed for describing the implementations or the existing technology. Clearly, the accompanying drawings in the following description show merely some implementations recorded in the implementations of the present specification, and a person of ordinary skill in the art can still derive other drawings from these accompanying drawings.

FIG. 1 is a schematic diagram illustrating a payment interaction process in a multi-currency transaction scenario, according to the present specification;

FIG. 2 is a schematic diagram illustrating a refund interaction process in a multi-currency transaction scenario, according to the present specification;

FIG. 3 is a schematic flowchart illustrating a multi-currency refund service processing method, according to an implementation of the present specification;

FIG. 4 is a schematic structural diagram illustrating a multi-currency refund service processing apparatus, according to an implementation of the present specification;

FIG. 5 is a schematic structural diagram illustrating a refund amount calculation module, according to an implementation of the present specification;

FIG. 6 is a schematic structural diagram illustrating a historical record read module, according to an implementation of the present specification;

FIG. 7 is a schematic structural diagram illustrating a device configured to configure the apparatus in the implementations of the present specification.

### DESCRIPTION OF IMPLEMENTATIONS

To make a person skilled in the art better understand the technical solutions in the implementations of the present specification, the following describes the technical solutions in the implementations of the present specification in detail with reference to the accompanying drawings in the implementations of the present specification. Clearly, the described implementations are merely some but not all of the implementations of the present specification. All other implementations obtained by a person of ordinary skill in the art based on the implementations of the present specification shall fall within the protection scope.

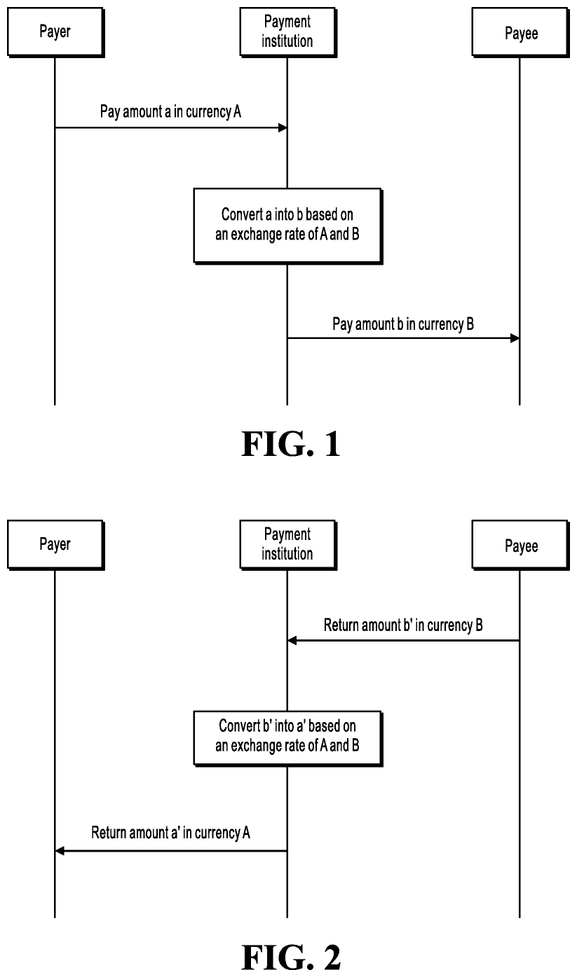

FIG. 1 is a schematic diagram illustrating an interaction process in which a payer and a payee separately use different currencies to complete a transaction by using a payment institution in a multi-currency transaction scenario.

It can be understood that the payer and the payee in the implementations of the present specification can be a buyer and a seller respectively. For example, if the payment institution directly performs conversion between currencies used by the buyer and the seller, a transaction process can relate to only the buyer (payer), the payment institution, and the seller (payee). Alternatively, the payer and the payee in the implementations of the present specification can be a buyer and another intermediate institution respectively, or can be another intermediate institution and a seller respectively. For example, a domestic buyer (payer) in China pays an amount to domestic ALIPAY (payment institution) in RMBs; domestic ALIPAY converts the amount into more common dollars and then pays the dollars to overseas ALIPAY (payee) (as a payer); and overseas ALIPAY (payment institution) converts the dollars into euros and then pays the euros to a domestic seller (payee) in Europe. Therefore, the payer and the payee can correspond to different transaction parties in different application scenarios. No limitation is imposed thereto in the implementations of the present specification.

Assume that for the two transaction parties shown in FIG. 1, the payer pays an amount in currency A, and the payee receives an amount in currency B, when the payer pays a transaction amount to the payee, actually, the payer first pays to the payment institution; and after receiving amount “a” paid by the payer in currency A, the payment institution converts a value of amount “a” into a value of amount “b” based on an exchange rate for conversion between currency A and currency B, such as a specified exchange rate agreed upon by the two transaction parties through negotiation, or the current instantaneous exchange rate of the two currencies, and then the payment institution pays to the payee, so that the payee receives amount “b” paid in currency B.

For example, assume that the payer pays an amount in euros, the payee receives an amount in dollars, and the two parties agree to perform a transaction at the following exchange rate: 1 dollar=0.8423 euros, when the payer pays 0.84 euros to the payment institution, the payment institution pays 1 dollar to the payee after performing conversion based on the exchange rate.

Most exchange rates used in multi-currency transaction scenarios are accurate to 2 to 4 digits after a decimal point, and most transaction amounts of currencies are accurate to 0 to 2 digits after a decimal point. Therefore, after a transaction amount is converted based on an exchange rate, decimal rounding is usually needed.

In a transaction payment process, if the payment institution first obtains a payable amount of the payer by performing conversion based on the price of a product, a gain/loss resulting from rounding is actually undertaken by the payee or payer. In a transaction process, if the payer pays an amount, and the payment institution converts the amount based on an exchange rate and performs rounding, a gain/loss resulting from the rounding may be undertaken by the payment institution. However, the probability of rounding down and the probability of rounding up should be approximately equivalent based on a rounding method used by the payment institution, such as omitting decimal fractions smaller than 0.5 and counting all others, including 0.5, as 1, or rounding half to even. Therefore, when a relatively large quantity of multi-currency transactions are performed by using the payment institution, a loss and a gain undertaken by the payment institution should also be approximately equivalent.

FIG. 2 is a schematic diagram illustrating an interaction process in which a payer and a payee implement a multi-currency refund by using a payment institution when a transaction refund occurs between the payer and the payee in a multi-currency transaction scenario.

In a multi-currency refund scenario, a refund amount is usually converted based on an exchange rate used during transaction payment. In the refund process shown in FIG. 2, if the payee returns only a partial amount to the payer, that is, b′ is less than b, the payment institution needs to convert b′ into a′ based on the original exchange rate of A and B used during transaction payment, and then returns a′ to the payer.

The previous transaction is still used as an example. Assume that the payee returns 0.02 dollars to the payment institution in a certain refund, after performing conversion based on the previous exchange rate: 1 dollar=0.8423 euros, the payment institution can determine that an amount that needs to be returned to the payer is 0.02*0.8423=0.016846. As described above, the conversion result needs to be rounded. In this case, the payment institution needs to return 0.02 euros to the payer, and therefore the payment institution needs to bear a loss of 0.003154 euros. If the payee returns 0.02 dollars to the payer again, the payment institution bears a loss of 0.003154 euros again after performing conversion again. Clearly, if the payee and the payer perform multiple previous or similar refund operations in which the payment institution needs to bear losses, a loss of the payment institution is multiplied.

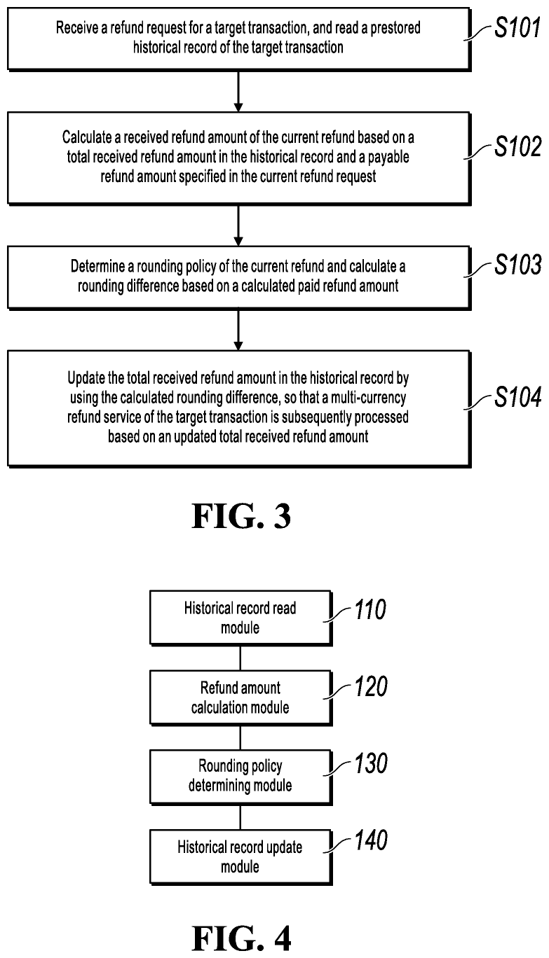

To alleviate the previous problem, the present specification provides a multi-currency refund service processing method. As shown in FIG. 3, the method can include the following steps.

S101. Receive a refund request for a target transaction, and read a pre-stored historical record of the target transaction.

A refund between two parties of the target transaction can be actively initiated by a payer, and the refund request for the target transaction is generated after a payee agrees with the refund or the refund is validated by enforcement; or can be actively initiated by the payee to generate the refund request for the target transaction.

The generated refund request can include information such as an ID of the current refund, a receivable refund amount returned by the payee to the payer, and a transaction ID of the corresponding target transaction. After the refund request is sent to a payment institution, the payment institution can read the pre-stored historical record of the target transaction based on the information included in the refund request, to process the current refund service based on historical data of the transaction and historical refunds and real-time data of the current refund.

Specifically, the historical record of the target transaction can be determined and read by using multiple methods. No limitation is imposed thereto in this implementation of the present specification.

For example, each transaction in a multi-currency transaction scenario can have a unique transaction ID, and the unique transaction ID can be recorded in a database together with other information such as a payer, a payee, a transaction time, a receivable payment amount, and a received payment amount of the transaction. The generated refund request includes the transaction ID of the corresponding target transaction. After receiving the refund request, the payment institution can obtain the transaction ID from the refund request.

In a specific implementation, when the pre-stored historical record of the target transaction needs to be read, the ID of the target transaction included in the refund request can be first obtained, and then a pre-stored full transaction historical record can be searched for the historical record of the target transaction based on the obtained ID.

S102. Calculate a received refund amount of the current refund based on a total received refund amount in the historical record and a payable refund amount specified in the current refund request.

In a specific implementation provided in this implementation of the present specification, when the received refund amount of the current refund is calculated, the total received refund amount is calculated by using the current refund and the historical refunds as one entire refund based on a receivable payment amount and a received payment amount of the target transaction, a receivable refund amount of the current refund, a total receivable refund amount and a total received refund amount of the historical refunds, such that the total received refund amount can be used to calculate the current received refund amount. Therefore, after the refund request for the target transaction is received and the historical record of the target transaction is read, the previous amounts need to be obtained.

Specifically, the previous amounts in the historical record can be obtained by using multiple methods. No limitation is imposed thereto in this implementation of the present specification.

In a specific implementation, the receivable payment amount P and the received payment amount R of the target transaction can be obtained from transaction information in the found historical record of the target transaction.

In addition, the generated refund request can further include the receivable refund amount rₖ of the current refund, or the receivable refund amount rₖ of the current refund can be directly obtained.

Each refund of each transaction in a multi-currency transaction scenario can also have a unique refund ID, and the unique refund ID is recorded in a historical record together with other information such as a corresponding transaction ID, a payer, a payee, a refund time, a receivable refund amount, and a received refund amount of the current refund.

Each piece of refund information of the historical refunds of the target transaction can be determined from the found historical record of the target transaction. For each piece of determined refund information, a receivable refund amount and a received refund amount of the current historical refund are obtained, and then a sum of obtained receivable refund amounts of the historical refunds is calculated as the total receivable refund amount r_{Σ}, and a sum of obtained received refund amounts of the historical refunds is calculated as the total received refund amount p_{Σ}.

In addition, information such as a total receivable refund amount and a total received refund amount that are obtained after each time of refund processing can be further recorded in a historical record in a form of accumulated historical refund information. The accumulated historical refund information is determined from the found historical record of the target transaction, and the total receivable refund amount r_{Σ} and the total received refund amount p_{Σ} of the historical refunds of the target transaction are obtained from the accumulated historical refund information.

In a multi-currency refund scenario, any generally initiated refund is a normal refund. For example, only a few refunds are performed for a certain transaction, or an exchange rate-based conversion result of each refund is rounded. There is a relatively low proportion of the following case in multi-currency refunds: Multiple malicious refunds are performed by using a rounding loophole in exchange rate-based conversion, and a loss of a payment institution is expanded due to accumulation of amount deviations. Therefore, a trigger condition can also be set for the historical data acquisition method provided in the present specification, to simplify a normal multi-currency refund service processing process.

Whether the target transaction satisfies the predetermined trigger condition is determined based on the refund request; and if the target transaction does not satisfy the predetermined trigger condition, the total receivable refund amount r_{Σ} and the total received refund amount p_{Σ} both with a value of 0 are obtained; or if the target transaction satisfies the predetermined trigger condition, the total receivable refund amount r_{Σ} and the total received refund amount p_{Σ} of the historical refunds are obtained from the historical record.

It can be understood that, the previous specific methods for obtaining the historical data from the historical record can be separately or jointly used. No limitation is imposed thereto in this implementation of the present specification.

Alternatively, the predetermined trigger condition can be set by a person skilled in the art based on an actual application scenario.

For example, the predetermined trigger condition can be that the target transaction has historical refunds. If the target transaction has historical refunds, a total receivable refund amount r_{Σ} and a total received refund amount p_{Σ} of the historical refunds are further obtained; or if the target transaction has no historical refund, the total receivable refund amount r_{Σ} and the total received refund amount p_{Σ} of the historical refunds are both determined as 0, and are unnecessarily further obtained. Alternatively, the predetermined trigger condition can be that N historical refunds have been performed, etc.

For another example, the predetermined trigger condition can be that the target transaction has a refund loss. That is, if the payment institution has a loss in rounding in a previous refund of the target transaction, amount information of the historical refund is further obtained.

Alternatively, the trigger condition can be set based on the two transaction parties of the target transaction. For example, the trigger condition can be that a refund rate of the payer and/or a refund rate of the payee are/is higher than a predetermined threshold, a credit value of the payer and/or a credit value of the payee are/is lower than a predetermined threshold, or a refund compensation amount of the payer and/or a refund compensation amount of the payee are/is higher than a predetermined threshold.

According to the multi-currency refund service processing solution provided in implementations of the present specification, the received refund amount of the current refund is calculated based on the following principle: A total received refund amount calculated by using refunds of the same transaction as one refund should be equal to a sum of separately calculated received refund amounts of the refunds. When the total received refund amount is calculated, due to the same exchange rate used for conversion, in actual calculation, the exchange rate is offset directly. Therefore, the previous principle is actually equivalent to that a payer amount proportion should be equal to a payee amount proportion when the same exchange rate is used for conversion. The previous principle is also equivalent to that a payer amount proportion and a payee amount proportion that are used during transaction payment should be equal to a payer amount proportion and a payee amount proportion that are used during refund.

Multiple forms of formulas can be used to calculate the received refund amount of the current refund based on the previous principle. No limitation is imposed thereto in this implementation of the present specification.

For example, if a receivable refund amount and a received refund amount of the transaction, the receivable refund amount of the current refund, and the receivable refund amounts and the received refund amounts of historical refunds are separately obtained based on the refund request, the following formula can be used to calculate the received refund amount pₖ of the current refund:

$${p}_{k} = [ \frac{( {\sum }_{i = 1}^{n} {r}_{i} ) + {r}_{k}}{R} ] * p - {\sum }_{i = 1}^{n} {p}_{i} , \qquad ( 1 )$$

where
n is a quantity of historical refunds of the target transaction;
rᵢ is a receivable refund amount of the ith historical refund of the target transaction (i=1, 2, . . . , n);
rₖ is the receivable refund amount of the current refund of the target transaction;
R is the received payment amount of the target transaction;
P is the receivable payment amount of the target transaction; and
pᵢ is a received refund amount of the ith historical refund of the target transaction (i=1, 2, . . . , n).

If accumulated information of historical refunds, such as a total receivable refund amount r_{Σ} and a total received refund amount p_{Σ}, is recorded during each time of refund processing, the following formula can be used to calculate the received refund amount pₖ of the current refund:

$${p}_{k} = [ \frac{{r}_{Σ} + {r}_{k}}{R} ] * p - {p}_{Σ} , \qquad ( 2 )$$

rₖ is the receivable refund amount of the current refund of the target transaction;
R is the received payment amount of the target transaction; and
P is the receivable payment amount of the target transaction.

If it is determined that the target transaction has no historical refund, or there is another case in which the trigger condition is not satisfied, the following formula can be used to calculate the received refund amount pₖ of the current refund:

$${p}_{k} = \frac{{r}_{k}}{R} * p , \qquad ( 3 )$$

where
rₖ is the receivable refund amount of the current refund of the target transaction;
R is the received payment amount of the target transaction; and
P is the receivable payment amount of the target transaction.

S103. Determine a rounding policy of the current refund and calculate a rounding difference based on a calculated paid refund amount.

S104. Update the total received refund amount in the historical record by using the calculated rounding difference, so that a multi-currency refund service of the target transaction is subsequently processed based on an updated total received refund amount.

For ease of description, S103 and S104 are jointly described.

After the paid refund amount of the current refund is calculated, the rounding policy of the current refund can be further determined. Generally, rounding down or rounding up for the paid refund amount of the current refund can be determined based on a general rounding rule such as omitting decimal fractions smaller than 0.5 and counting all others, including 0.5, as 1, or round half to even, and after the determining, a rounding down difference or a rounding up difference can be further calculated. For a possible next refund service, the current refund is equivalent to a historical refund. Therefore, the total received refund amount in the historical record needs to be updated by using the current rounding down difference or rounding up difference.

With reference to a more specific example, the following describes the multi-currency refund service processing method provided in the present specification.

In a cross-border shopping platform, a European buyer and a US seller have completed a transaction for a product with a price of 1 dollar. A payment institution determines that the buyer needs to pay 0.84 euros based on the following exchange rate: 1 dollar=0.8423 euros. Therefore, the buyer pays 0.84 euros to the payment institution, and the seller receives 1 dollar paid by the payment institution.

Then, the seller initiates a refund of 0.02 dollars to the payment institution for the transaction.

This is the first refund of the transaction. When the current refund service is processed, a receivable payment amount 0.84 euros and a received payment amount 1 dollar of the transaction are obtained by reading a historical record, and a total receivable refund amount and a total received refund amount of historical refunds that are both 0 are obtained based on a predetermined trigger condition: whether a historical refund exists. Therefore, a received refund amount of the current refund can be calculated as 0.02/1*0.84=0.0168 euros, and based on this, it is determined that a rounding policy of the current refund is rounding up and a rounding up difference is 0.0032 euros, that is, the payment institution pays 0.02 euros to the buyer after bearing a loss of 0.0032 euros.

Then, data of the first refund needs to be updated in the historical record. That is, the total receivable refund amount of historical refunds is updated to 0.02 dollars, and the total received refund amount of historical refunds is updated to 0.02 euros (received refund amount 0.0168+difference).

Then, the seller initiates a refund of 0.02 dollars to the payment institution again for the transaction, that is, the second refund. When the current refund service is processed, if a received refund amount is calculated separately for the current refund, the current refund should be the same as the previous refund, and the payment institution pays 0.02 euros to the buyer after bearing a loss of 0.0032 euros.

However, according to the solutions provided in the present specification, the receivable payment amount 0.84 euros and the received payment amount 1 dollar of the transaction and the total receivable refund amount 0.02 dollars and the total received refund amount 0.02 euros of historical refunds are obtained based on the read historical record. Therefore, the received refund amount of the current refund can be calculated as (0.02+0.02)/1*0.84−0.02=0.0136 euros, and it is further determined that a rounding policy is rounding down and a rounding down difference is 0.0036 euros, that is, the payment institution pays 0.01 euros to the buyer after obtaining a gain of 0.0036 euros.

Then, the total receivable refund amount of historical refunds still needs to be updated in the historical record based on the current rounding down difference.

It can be seen that, according to the solutions in the implementations of the present specification, when a multi-currency refund service is processed, a total received refund amount is calculated by using refunds of the same transaction as one refund, and then rounding is performed at one time, so that amount deviations of multiple refunds can be balanced, to effectively alleviate deviation accumulation and expansion.

Corresponding to the previous method implementation, an implementation of the present specification further provides a multi-currency refund service processing apparatus. Referring to FIG. 4, the apparatus can include: a historical record read module 110, configured to receive a refund request for a target transaction, and read a pre-stored historical record of the target transaction; a refund amount calculation module 120, configured to calculate a received refund amount of the current refund based on a total received refund amount in the historical record and a payable refund amount specified in the current refund request; a rounding policy determining module 130, configured to determine a rounding policy of the current refund and calculate a rounding difference based on a calculated paid refund amount; and a historical record update module 140, configured to update the total received refund amount in the historical record by using the calculated rounding difference, so that a multi-currency refund service of the target transaction is subsequently processed based on an updated total received refund amount.

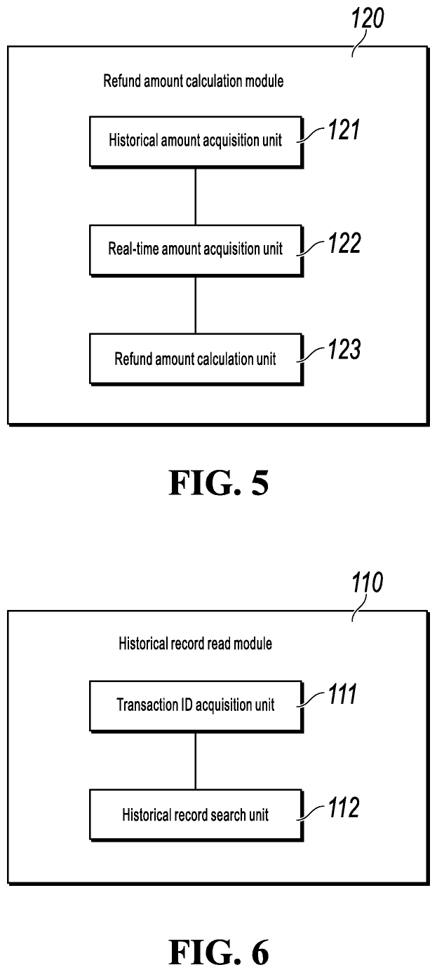

In a specific implementation provided in the present specification, referring to FIG. 5, the refund amount calculation module 120 can include: a historical amount acquisition unit 121, configured to obtain a receivable payment amount P and a received payment amount R of the target transaction and a total receivable refund amount r_{Σ} and a total received refund amount p_{Σ} of historical refunds from the historical record; a real-time amount acquisition unit 122, configured to obtain a receivable refund amount rₖ specified in the current refund request; and a refund amount calculation unit 123, configured to calculate the received refund amount pₖ of the current refund based on the principle that a payer amount proportion is equal to a payee amount proportion, where the payer amount proportion is

$$\frac{{p}_{k} + {p}_{Σ}}{P} ,$$

and the payee amount proportion is

$$\frac{{r}_{k} + {r}_{Σ}}{R} .$$

In a specific implementation provided in the present specification, referring to FIG. 6, the historical record read module 110 can include: a transaction ID acquisition unit 111, configured to obtain an ID of the target transaction included in the refund request; and a historical record search unit 112, configured to search a pre-stored full transaction historical record for the historical record of the target transaction based on the obtained ID.

In a specific implementation provided in the present specification, the historical amount acquisition unit 121 can be specifically configured to: obtain the receivable payment amount P and the received payment amount R of the target transaction from transaction information in the found historical record of the target transaction.

In a specific implementation provided in the present specification, the historical amount acquisition unit 121 can be specifically configured to: determine each piece of refund information of the historical refunds of the target transaction from the found historical record of the target transaction; for each piece of determined refund information, obtain a receivable refund amount and a received refund amount of the current historical refund; and calculate a sum of obtained receivable refund amounts of the historical refunds as the total receivable refund amount r_{Σ}, and calculate a sum of obtained received refund amounts of the historical refunds as the total received refund amount p_{Σ}.

In a specific implementation provided in the present specification, the historical amount acquisition unit 121 can be specifically configured to: determine accumulated historical refund information of the target transaction from the found historical record of the target transaction; and obtain the total receivable refund amount r_{Σ} and the total received refund amount p_{Σ} of the historical refunds of the target transaction from the determined accumulated historical refund information.

In a specific implementation provided in the present specification, the historical amount acquisition unit 121 can be specifically configured to: determine, based on the refund request, whether the target transaction satisfies a predetermined trigger condition; and if the target transaction does not satisfy the predetermined trigger condition, obtain the total receivable refund amount r_{Σ} and the total received refund amount p_{Σ} both with a value of 0; or if the target transaction satisfies the predetermined trigger condition, obtain the total receivable refund amount r_{Σ} and the total received refund amount p_{Σ} of the historical refunds from the historical record.

For a specific implementation process of functions of each module in the apparatus, references can be made to an implementation process of a corresponding step in the previous method. Details are omitted here for simplicity.

An implementation of the present specification further provides a computer device, where the computer device includes at least a memory, a processor, and a computer program that is stored in the memory and that can run on the processor, and the processor implements the previous multi-currency refund service processing method when executing the program. The method includes at least the following steps: receiving a refund request for a target transaction, and reading a pre-stored historical record of the target transaction; calculating a received refund amount of the current refund based on a total received refund amount in the historical record and a payable refund amount specified in the current refund request; determining a rounding policy of the current refund and calculating a rounding difference based on a calculated paid refund amount; and updating the total received refund amount in the historical record by using the calculated rounding difference, so that a multi-currency refund service of the target transaction is subsequently processed based on an updated total received refund amount.

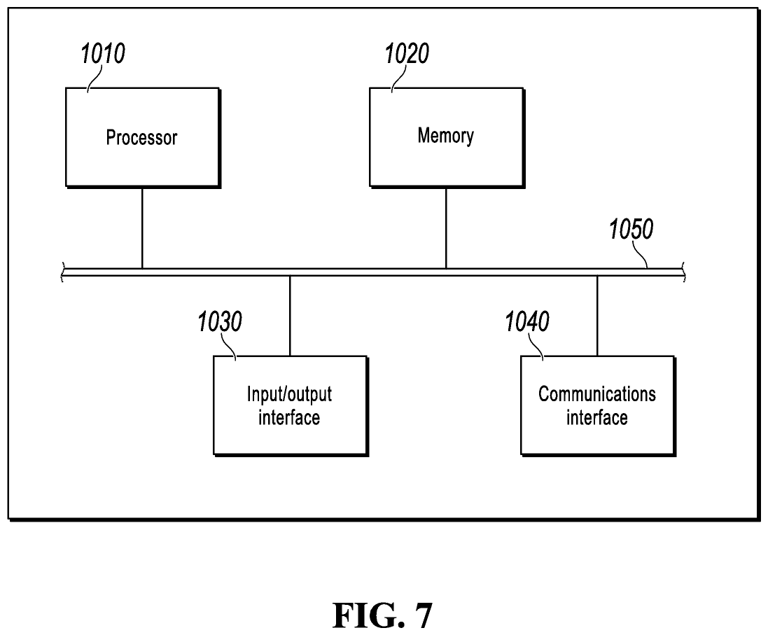

FIG. 7 is a schematic diagram illustrating a more specific hardware structure of a computing device, according to an implementation of the present specification. The device can include a processor 1010, a memory 1020, an input/output interface 1030, a communications interface 1040, and a bus 1050. The processor 1010, the memory 1020, the input/output interface 1030, and the communications interface 1040 implement mutual communicative connections inside the device by using the bus 1050.

The processor 1010 can be implemented by using a general-purpose central processing unit (CPU), a microprocessor, an application-specific integrated circuit (ASIC), one or more integrated circuits, etc. The processor 1010 is configured to execute a related program, to implement the technical solutions provided in the implementations of the present specification.

The memory 1020 can be implemented by using a read-only memory (ROM), a random access memory (RAM), a static storage device, a dynamic storage device, etc. The memory 1020 can store an operating system and other application programs. When the technical solutions provided in the implementations of the present specification are implemented by using software or firmware, related program code is stored in the memory 1020 and is invoked and executed by the processor 1010.

The input/output interface 1030 is configured to be connected to an input/output module to input/output information. The input/output module can be configured in the device as a component (not shown in the figure), or can be externally connected to the device to provide a corresponding function. The input module can include a keyboard, a mouse, a touchscreen, a microphone, various sensors, etc. The output module can include a display, a speaker, an oscillator, an indicator, etc.

The communications interface 1040 is configured to be connected to a communications module (not shown in the figure), to implement communicative interaction between the device and another device. The communications module can implement communication in a wired way (for example, by using a USB or a network cable), or can implement communication in a wireless way (for example, by using a mobile network, Wi-Fi, or Bluetooth).

The bus 1050 includes a channel for transmitting information between components (such as the processor 1010, the memory 1020, the input/output interface 1030, and the communications interface 1040) of the device.

It is worthwhile to note that, although only the processor 1010, the memory 1020, the input/output interface 1030, the communications interface 1040, and the bus 1050 of the device are shown, in a specific implementation process, the device can further include another component needed for implementing normal operation. In addition, a person skilled in the art can understand that the device can include only components needed for implementing the solutions in the implementations of the present specification, and unnecessarily includes all the components shown in the figure.

An implementation of the present specification further provides a computer readable storage medium, where the computer readable storage medium stores a computer program, and the previous multi-currency refund service processing method is implemented when the program is executed by a processor. The method includes at least the following steps: receiving a refund request for a target transaction, and reading a pre-stored historical record of the target transaction; calculating a received refund amount of the current refund based on a total received refund amount in the historical record and a payable refund amount specified in the current refund request; determining a rounding policy of the current refund and calculating a rounding difference based on a calculated paid refund amount; and updating the total received refund amount in the historical record by using the calculated rounding difference, so that a multi-currency refund service of the target transaction is subsequently processed based on an updated total received refund amount.

The computer readable medium includes persistent, non-persistent, movable, and unmovable media that can store information by using any method or technology. The information can be a computer readable instruction, a data structure, a program module, or other data. Examples of the computer storage medium include but are not limited to a phase-change RAM (PRAM), a static RAM (SRAM), a dynamic RAM (DRAM), a RAM of another type, a ROM, an electrically erasable programmable read only memory (EEPROM), a flash memory or another memory technology, a compact disc read-only memory (CD-ROM), a digital versatile disc (DVD) or another optical storage, a cassette, a cassette magnetic disk storage, or another magnetic storage device, or any other non-transmission medium. The computer storage medium can be configured to store information accessible to a computing device. As defined in the present specification, the computer readable medium does not include computer readable transitory media such as a modulated data signal and a carrier.

It can be seen from the previous descriptions of the implementations that, a person skilled in the art can clearly understand that the implementations of the present specification can be implemented by using software and a necessary general hardware platform. Based on such an understanding, the technical solutions in the implementations of the present specification essentially or the part contributing to the existing technology can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to perform the method described in the implementations of the present specification or in some parts of the implementations of the present specification.

The system, apparatus, module, or unit illustrated in the previous implementations can be specifically implemented by using a computer chip or an entity, or can be implemented by using a product having a certain function. A typical implementation device is a computer, and a specific form of the computer can be a personal computer, a laptop computer, a cellular phone, a camera phone, a smartphone, a personal digital assistant, a media player, a navigation device, an email sending/receiving device, a game console, a tablet computer, a wearable device, or any combination of these devices.

The implementations of the present specification are described in a progressive way. For same or similar parts of the implementations, mutual references can be made to the implementations. Each implementation focuses on a difference from other implementations. Particularly, an apparatus implementation is basically similar to a method implementation, and therefore is described briefly. For a related part, references can be made to some descriptions in the method implementation. The previously described apparatus implementations are merely examples. The modules described as separate parts can or cannot be physically separate. During implementation of the solutions in the implementations of the present specification, functions of the modules can be implemented in one or more pieces of software and/or hardware. Some or all of the modules can be selected based on an actual need to implement the solutions of the implementations. A person of ordinary skill in the art can understand and implement the implementations of the present specification without creative efforts.

The previous descriptions are merely specific implementations of the implementations of the present specification. It is worthwhile to note that a person of ordinary skill in the art can further make improvements or polishing without departing from the principle of the implementations of the present specification, and the improvements or polishing shall fall within the protection scope of the implementations of the present specification.

What is claimed is:

1. A computer-implemented method for multi-currency refund service processing comprising:
receiving a refund request for a target transaction;
in response to receiving the refund request, determining a pre-stored historical record of the target transaction;
calculating a received refund amount of a current refund based on a total received refund amount in the historical record and a payable refund amount specified in the refund request;
determining a rounding policy of the current refund and calculating a rounding difference based on a calculated paid refund amount;
updating the total received refund amount in the historical record by using the calculated rounding difference; and
generating a multi-currency refund service of the target transaction to be processed based on an updated total received refund amount.

2. The computer-implemented method of claim 1, wherein calculating the received refund amount of the current refund based on the total received refund amount in the historical record and the payable refund amount specified in the refund request comprises:
obtaining a receivable payment amount P and a received payment amount R of the target transaction and a total receivable refund amount r_{Σ} and a total received refund amount p_{Σ} of historical refunds from the historical record;
obtaining a receivable refund amount rₖ specified in the refund request; and
calculating the received refund amount pₖ of the current refund based on a principle that a payer amount proportion is equal to a payee amount proportion, wherein the payer amount proportion is
$$\frac{{p}_{k} + {p}_{Σ}}{P} ,$$
and the payee amount proportion is
$$\frac{{r}_{k} + {r}_{Σ}}{R} .$$

3. The computer-implemented method of claim 2, wherein determining the pre-stored historical record of the target transaction comprises:
obtaining an ID of the target transaction comprised in the refund request; and
searching a pre-stored full transaction historical record for the historical record of the target transaction based on the obtained ID.

4. The computer-implemented method of claim 3, wherein obtaining the receivable payment amount P and the received payment amount R of the target transaction from the historical record comprises:
obtaining the receivable payment amount P and the received payment amount R of the target transaction from transaction information in the historical record of the target transaction.

5. The computer-implemented method of claim 3, wherein obtaining the total receivable refund amount r_{Σ} and the total received refund amount p_{Σ} of the historical refunds from the historical record comprises:
determining each piece of refund information of the historical refunds of the target transaction from the historical record of the target transaction;
for each piece of the refund information, obtaining a receivable refund amount and a received refund amount of a current historical refund; and
calculating a sum of obtained receivable refund amounts of the historical refunds as the total receivable refund amount r₉₃ , and calculating a sum of obtained received refund amounts of the historical refunds as the total received refund amount p_{Σ}.

6. The computer-implemented method of claim 3, wherein obtaining the total receivable refund amount r_{Σ} and the total received refund amount p_{Σ} of the historical refunds from the historical record comprises:
determining accumulated historical refund information of the target transaction from the historical record of the target transaction; and
obtaining the total receivable refund amount r_{Σ} and the total received refund amount p_{Σ} of the historical refunds of the target transaction from the determined accumulated historical refund information.

7. The computer-implemented method of claim 2, wherein obtaining the total receivable refund amount r_{Σ} and the total received refund amount p_{Σ} of the historical refunds from the historical record comprises:
determining, based on the refund request, whether the target transaction satisfies a predetermined trigger condition; and
if the target transaction does not satisfy the predetermined trigger condition, obtaining the total receivable refund amount r_{Σ} and the total received refund amount p_{Σ} both with a value of 0; or
if the target transaction satisfies the predetermined trigger condition, obtaining the total receivable refund amount r_{Σ} and the total received refund amount p_{Σ} of the historical refunds from the historical record.

8. A non-transitory, computer-readable medium storing one or more instructions executable by a computer system to perform operations comprising:
receiving a refund request for a target transaction;
in response to receiving the refund request, determining a pre-stored historical record of the target transaction;
calculating a received refund amount of a current refund based on a total received refund amount in the historical record and a payable refund amount specified in the refund request;
determining a rounding policy of the current refund and calculating a rounding difference based on a calculated paid refund amount;
updating the total received refund amount in the historical record by using the calculated rounding difference; and
generating a multi-currency refund service of the target transaction to be processed based on an updated total received refund amount.

9. The non-transitory, computer-readable medium of claim 8, wherein calculating the received refund amount of the current refund based on the total received refund amount in the historical record and the payable refund amount specified in the refund request comprises:
obtaining a receivable payment amount P and a received payment amount R of the target transaction and a total receivable refund amount r_{Σ} and a total received refund amount p_{Σ} of historical refunds from the historical record;
obtaining a receivable refund amount rₖ specified in the refund request; and
calculating the received refund amount pₖ of the current refund based on a principle that a payer amount proportion is equal to a payee amount proportion, wherein the payer amount proportion is
$$\frac{{p}_{k} + {p}_{Σ}}{P} ,$$
and the payee amount proportion is
$$\frac{{r}_{k} + {r}_{Σ}}{R} .$$

10. The non-transitory, computer-readable medium of claim 9, wherein determining the pre-stored historical record of the target transaction comprises:
obtaining an ID of the target transaction comprised in the refund request; and
searching a pre-stored full transaction historical record for the historical record of the target transaction based on the obtained ID.

11. The non-transitory, computer-readable medium of claim 10, wherein obtaining the receivable payment amount P and the received payment amount R of the target transaction from the historical record comprises:
obtaining the receivable payment amount P and the received payment amount R of the target transaction from transaction information in the historical record of the target transaction.

12. The non-transitory, computer-readable medium of claim 10, wherein obtaining the total receivable refund amount r_{Σ} and the total received refund amount p_{Σ} of the historical refunds from the historical record comprises:
determining each piece of refund information of the historical refunds of the target transaction from the historical record of the target transaction;
for each piece of the refund information, obtaining a receivable refund amount and a received refund amount of a current historical refund; and
calculating a sum of obtained receivable refund amounts of the historical refunds as the total receivable refund amount r_{Σ}, and calculating a sum of obtained received refund amounts of the historical refunds as the total received refund amount p_{Σ}.

13. The non-transitory, computer-readable medium of claim 10, wherein obtaining the total receivable refund amount r_{Σ} and the total received refund amount p_{Σ} of the historical refunds from the historical record comprises:
determining accumulated historical refund information of the target transaction from the historical record of the target transaction; and
obtaining the total receivable refund amount r_{Σ} and the total received refund amount p_{Σ} of the historical refunds of the target transaction from the determined accumulated historical refund information.

14. The non-transitory, computer-readable medium of claim 9, wherein obtaining the total receivable refund amount r_{Σ} and the total received refund amount p_{Σ} of the historical refunds from the historical record comprises:
determining, based on the refund request, whether the target transaction satisfies a predetermined trigger condition; and
if the target transaction does not satisfy the predetermined trigger condition, obtaining the total receivable refund amount r_{Σ} and the total received refund amount p_{Σ} both with a value of 0; or
if the target transaction satisfies the predetermined trigger condition, obtaining the total receivable refund amount r_{Σ} and the total received refund amount p_{Σ} of the historical refunds from the historical record.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a refund request for a target transaction;
in response to receiving the refund request, determining a pre-stored historical record of the target transaction;
calculating a received refund amount of a current refund based on a total received refund amount in the historical record and a payable refund amount specified in the refund request;
determining a rounding policy of the current refund and calculating a rounding difference based on a calculated paid refund amount;
updating the total received refund amount in the historical record by using the calculated rounding difference; and
generating a multi-currency refund service of the target transaction to be processed based on an updated total received refund amount.

16. The computer-implemented system of claim 15, wherein calculating the received refund amount of the current refund based on the total received refund amount in the historical record and the payable refund amount specified in the refund request comprises:
obtaining a receivable payment amount P and a received payment amount R of the target transaction and a total receivable refund amount r_{Σ} and a total received refund amount p_{Σ} of historical refunds from the historical record;
obtaining a receivable refund amount rₖ specified in the refund request; and
calculating the received refund amount pₖ of the current refund based on a principle that a payer amount proportion is equal to a payee amount proportion, wherein the payer amount proportion is
$$\frac{{p}_{k} + {p}_{Σ}}{P} ,$$
and the payee amount proportion is
$$\frac{{r}_{k} + {r}_{Σ}}{R} .$$

17. The computer-implemented system of claim 16, wherein determining the pre-stored historical record of the target transaction comprises:
obtaining an ID of the target transaction comprised in the refund request; and
searching a pre-stored full transaction historical record for the historical record of the target transaction based on the obtained ID.

18. The computer-implemented system of claim 17, wherein obtaining the receivable payment amount P and the received payment amount R of the target transaction from the historical record comprises:
obtaining the receivable payment amount P and the received payment amount R of the target transaction from transaction information in the historical record of the target transaction.

19. The computer-implemented system of claim 17, wherein obtaining the total receivable refund amount r_{Σ} and the total received refund amount p_{Σ} of the historical refunds from the historical record comprises:
determining each piece of refund information of the historical refunds of the target transaction from the historical record of the target transaction;
for each piece of the refund information, obtaining a receivable refund amount and a received refund amount of a current historical refund; and
calculating a sum of obtained receivable refund amounts of the historical refunds as the total receivable refund amount r_{Σ} and calculating a sum of obtained received refund amounts of the historical refunds as the total received refund amount p_{Σ}.

20. The computer-implemented system of claim 17, wherein obtaining the total receivable refund amount r_{Σ} and the total received refund amount p_{Σ} of the historical refunds from the historical record comprises:
determining accumulated historical refund information of the target transaction from the historical record of the target transaction; and
obtaining the total receivable refund amount r_{Σ} and the total received refund amount p_{Σ} of the historical refunds of the target transaction from the determined accumulated historical refund information.

21. The computer-implemented system of claim 16, wherein obtaining the total receivable refund amount r_{Σ} and the total received refund amount p_{Σ} of the historical refunds from the historical record comprises:
determining, based on the refund request, whether the target transaction satisfies a predetermined trigger condition; and
if the target transaction does not satisfy the predetermined trigger condition, obtaining the total receivable refund amount r_{Σ} and the total received refund amount p_{Σ} both with a value of 0; or
if the target transaction satisfies the predetermined trigger condition, obtaining the total receivable refund amount r_{Σ} and the total received refund amount p_{Σ} of the historical refunds from the historical record.
